(19) United States
(12) Patent Application Publication
(10) Pub. No.: US 2014/0075381 A1
(43) Pub. Date: Mar. 13, 2014

(54) DATA TRANSMITTING DEVICE, DATA RECEIVING DEVICE, AND DATA EXCHANGING METHOD

(71) Applicant: TING LUO, Shenzhen City (CN)

(72) Inventor: TING LUO, Shenzhen City (CN)

(21) Appl. No.: 13/660,055

(22) Filed: Oct. 25, 2012

(30) Foreign Application Priority Data
Sep. 10, 2012 (CN) 2012103321236

(51) Int. Cl. G06F 3/048; G06F 3/041

(52) U.S. Cl. 715/810

(57) ABSTRACT

A data exchanging method is provided. A data transmitting device determines a first start position and a first end position of a first touch track according to sensing signals from a first touch display of the data transmitting device. If one icon is displayed on the first start position, and the first end position is on the edge of a first user interface, the data transmitting device transmits data corresponding to the icon to a server. A data receiving device determines a second start position of a second touch track according to sensing signals from a second touch display of the data receiving device. If the second start position is on the edge of a second user interface, the data receiving device transmits a download command to the server to request the server to transmit the data received from the data transmitting device to the data receiving device.

### BACKGROUND

1. Technical Field

The present disclosure relates to data transmitting and data receiving technology, and particularly, to a data transmitting device, a data receiving device, and a data exchanging method.

2. Description of Related Art

Data can be transmitted between portable electronic devices, for example mobile phones, through short distance wireless communication protocols. A conventional method for a portable electronic device to transmit data to another portable electronic device through short distance wireless communication usually includes selecting to-be-transmitted data in response to user input, searching for target electronic devices, displaying a list of the found target electronic devices, selecting one of the found target electronic devices, and transmitting the selected data to the selected electronic device. This conventional method is time-consuming.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of one embodiment of a data transmitting device.

FIG. 2 is a block diagram of one embodiment of a data receiving device.

FIG. 3 is a schematic view of one embodiment of a user interface provided by the data transmitting device of FIG. 1.

FIG. 4 is a schematic view of one embodiment of a user interface provided by the data receiving device of FIG. 2.

FIG. 5 is a flowchart of one embodiment of a data exchanging method.

### DETAILED DESCRIPTION

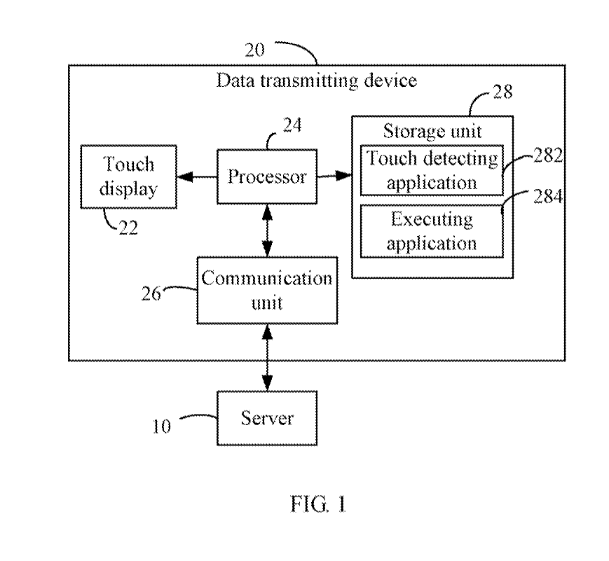

Referring to FIG. 1, a data transmitting device 20 of the embodiment is shown. The data transmitting device 20 includes a touch display 22, a processor 24, a communication unit 26, and a storage unit 28. The touch display 22 displays a user interface 222 including a number of icons. The communication unit 26 communicates between the data transmitting device 20 and a server 10. The storage unit 28 stores a touch determining application 282 and an executing application 284. The processor 24 executes the touch determining application 282 and the executing application 284 to perform functions of the electronic device 20.

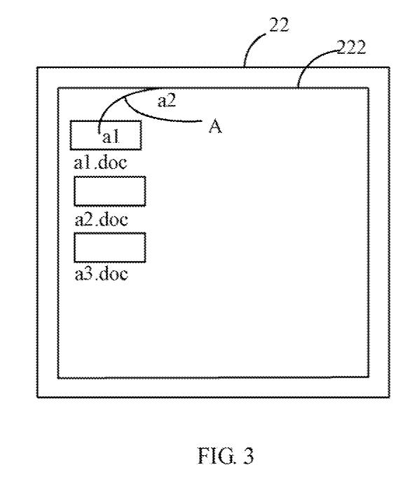

The touch determining application 282 is operable to determine a start position and an end position of a touch track according to sensing signals from the touch display 22. As shown in FIG. 3, the position al is the start position of the touch track A, and the position a2 is the end position of the touch track A. If one icon of the user interface 222 is displayed on the start position, and the end position is on the edge of the user interface 222, the executing application 284 is operable to transmit data corresponding to the icon displayed on the start position to the server 10. As shown in FIG. 3, the icon a1.doc is displayed on the start position a1, and the end position a2 is on the edge of the user interface 222, the executing application 284 is operable to transmit the file of a1.doc to the server 10. In this embodiment, if the end position is adjacent to the edge of the user interface 222, the executing application 284 is operable to determine that the end position is on the edge of the user interface 222.

The server 10 receives and stores the data from the data transmitting device 20. In this embodiment, the server 10 stores the data from the data transmitting device 20 for a preset period. After the preset period, the server 10 deletes the data received from the data transmitting device 20.

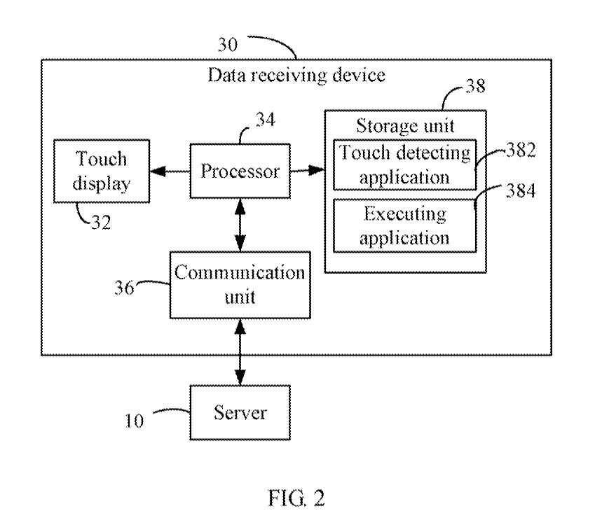

Referring to FIG. 2, a data receiving device 30 includes a touch display 32, a processor 34, a communication unit 36, and a storage unit 38. The touch display 32 displays a user interface 322 including a number of icons. The communication unit 36 communicates the data receiving device 30 with the server 10. The storage unit 38 stores a touch determining application 382 and an executing application 384. The processor 34 executes the touch determining application 382 and the executing application 384 to perform functions of the data receiving device 30.

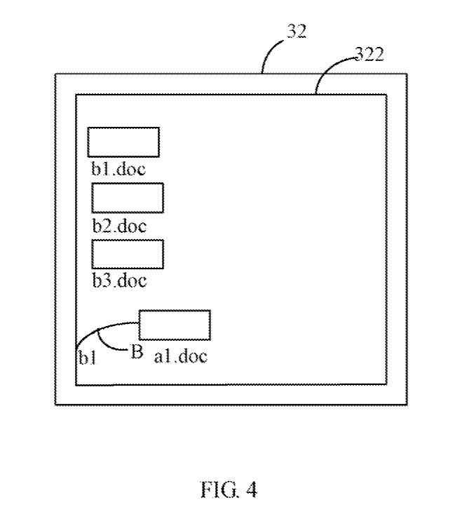

The touch determining application 382 is operable to determine a start position of a touch track according to sensing signals generated from the touch display 32. If the start position is on the edge of the user interface 322, the executing application 384 is operable to transmit a download command to the server 10. In this embodiment, the download command includes a friend list listing identifications of electronic devices of friends in the friend list. Data from each electronic device in the friend list is needed by the data receiving device 30. In this embodiment, the identification of the data transmitting device 20 is in the friend list. The server 10 determines that the data from the data transmitting device 20 is needed by the data receiving device 30 according to the download command, and transmits the data received from the data transmitting device 20 to the data receiving device 30. The executing application 34 is operable to display the icon corresponding to the data received from the server 10 on the user interface 322. As shown in FIG. 4, a1.doc is displayed on the user interface 322.

In this embodiment, as the server 10 stores the data received from the data transmitting device 20 for the preset period, if the server 10 receives the download command from the data receiving device 30 after the preset period, the server 10 transmits a message to the data receiving device 30 to prompt that no data needed by the data receiving device 30 is stored in the server 10.

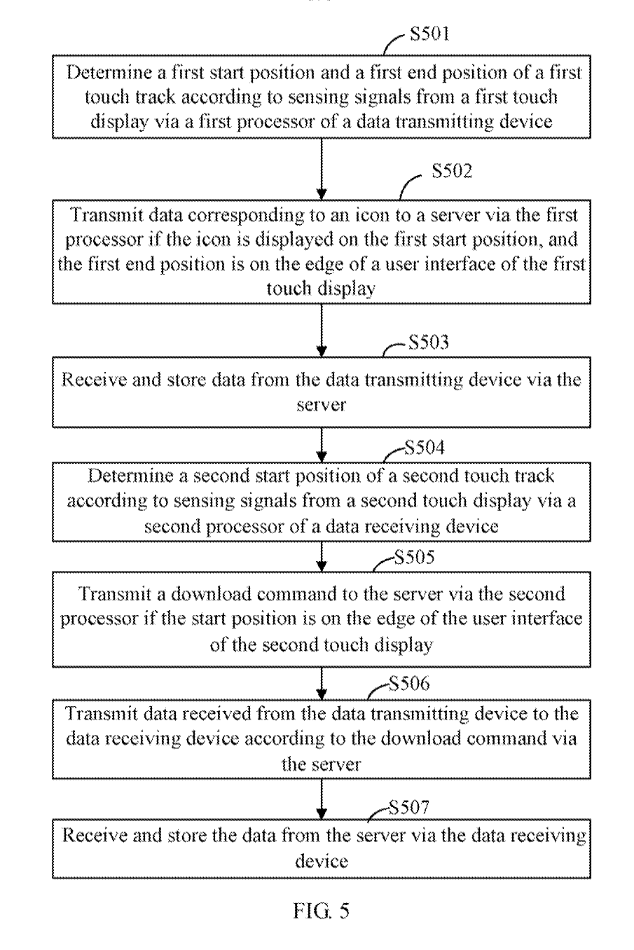

FIG. 5 is one embodiment of a data exchanging method.

In step S501, the touch determining application 282 is operable to determine a first start position and a first end position of a first touch track according to sensing signals from the touch display 22.

In step S502, if one icon of the user interface 222 is displayed on the first start position, and the first end position is on the edge of the user interface 222, the executing application 284 is operable to transmit data corresponding to the one icon to the server 10.

In step S503, the server 10 receives and stores the data from the data transmitting device 20.

In step S504, the touch determining application 382 determines a second start position of a second touch track according to sensing signals from the touch display 32.

In step S505, if the second start position is on the edge of the user interface 322, the executing application 384 is operable to transmit a download command to the server 10.

In step S506, the server 10 transmits the data received from the data transmitting device 20 to the data receiving device 30 according to the download command

In step S507, the executing application 384 is operable to receive and store the data from the server 10.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A data transmitting device comprising:
a communication unit to communicate the data transmitting device with a server;
a touch display displaying a user interface comprising at least one icon;
a storage unit storing a plurality of applications; and
a processor to execute the plurality of applications;
wherein the plurality of applications comprises instructions executable by the processor to:
determine a start position and an end position of a touch track according to sensing signals generated from the touch display; and
if one of the at least one icon of the user interface is displayed on the start position, and the end position is on the edge of the user interface, transmit the data corresponding to the one of the at least one icon to the server.

2. A data receiving device comprising:
a communication unit to communicate the data receiving device with a server;
a touch display displaying a user interface;
a storage unit storing a plurality of applications; and
a processor to execute the plurality of applications;
wherein, the plurality of applications comprises instructions executable by the processor to:
determine a start position of a touch track according to sensing signals generated from the touch display; and
if the start position is on the edge of the user interface, transmit a download command to the server to request the server to transmit data to the electronic device according to the download command, and receive and store the data transmitted from the server.

3. The data receiving device as described in claim 2, wherein the download command comprises a friend list listing identifications of electronic devices, and data from each of electronic devices in the friend list is needed by the data receiving device.

4. A data exchanging method applied in a data transmitting device, a data receiving device, and a server, the data transmitting device comprising a first touch display and a first processor, the data receiving device comprising a second touch display and a second processor, the first touch display displaying a first user interface comprising at least one icon, the second touch display displaying a second user interface, the method comprising:
determining a first start position and a first end position of a first touch track according to sensing signals from the first touch display via the first processor;
transmitting data corresponding to the one of the at least one icon to the server via the data transmitting device if one of the at least one icon is displayed on the first start position, and the first end position is on the edge of the first user interface;
receiving and storing the data from the data transmitting device via the server;
determining a second start position of a second touch track according to sensing signals from the second touch display via the second processor;
transmitting a download command to the server via the data receiving device if the second start position is on the edge of the second user interface;
transmitting the data received from the data transmitting device to the data receiving device according to the download command via the server; and
receiving and storing the data from the server via the second processor.

5. The method as described in claim 4, wherein the download command comprises a friend list listing identifications of electronic devices, data from each of the electronic devices in the friend list is needed by the data receiving device, and the identification of the data transmitting device is recorded in the friend list.

6. The method as described in claim 4, wherein the data from the data transmitting device is stored in the server for a preset period.

7. The method as described in claim 6, further comprising:
transmitting a message to the data receiving device via the server to prompt that no data needed by the data receiving device is stored in the server if the download command is received by the server after the preset period.
